(19) United States
(12) Patent Application Publication
(10) Pub. No.: US 2020/0372509 A1
(43) Pub. Date: Nov. 26, 2020

(54) DETECTING MALICIOUS TRANSACTIONS USING MULTI-LEVEL RISK ANALYSIS

(71) Applicant: PayPal, Inc., San Jose, CA (US)

(72) Inventor: Uttam Phalnikar, San Carlos, CA (US)

(21) Appl. No.: 16/421,153

(22) Filed: May 23, 2019

(51) Int. Cl. G06Q 20/40; G06N 20/00

(52) U.S. Cl. CPC G06Q 20/4016; G06N 20/00; G06Q 20/405

(57) ABSTRACT

Techniques are disclosed relating to detecting malicious transactions using multi-level risk analysis. In some embodiments, a server system may receive a transaction request for a transaction associated with a transaction system. In some embodiments, the server system may perform an initial risk-assessment to generate a risk score for the transaction, where the initial risk-assessment is an assessment procedure applied for transactions associated with a various transaction systems. In some embodiments, the server system may determine, based on the risk score, that the transaction does not pass the initial risk-assessment. The server system may determine, based on account information associated with the transaction system, whether a risk-assessment override option is enabled. In various embodiments, in response to a determination that the risk-assessment override option is enabled, the server system may perform additional fraud-detection operations to determine whether to authorize the transaction.

### BACKGROUND

### Technical Field

This disclosure relates generally to computer system security, and more particularly to detecting malicious transactions using multi-level risk analysis.

### Description of the Related Art

Server computer systems, such as web servers, application servers, email servers, etc., provide various computing resources and services to end users. For example, a server computer system may provide a web service that facilitates transactions for multiple transaction systems. In some instances, however, malicious third-parties may attempt malicious transactions using the web service. To limit such malicious activity, the web service may perform a risk-assessment to detect and prevent potentially malicious transactions attempted on its system. For example, the web service may block a transaction when the risk-assessment indicates that its probability for being malicious exceeds a certain threshold (e.g., 25%). In some instances, however, the transaction systems that use the web service may have a higher risk-tolerance than the web service itself.

### BRIEF DESCRIPTION OF THE DRAWINGS

FIG. 1 is a block diagram illustrating an example system for detecting malicious transactions using multi-level risk analysis, according to some embodiments.

FIG. 2 is a block diagram illustrating an example fraud-detection module, according to some embodiments.

FIG. 3 is a flow diagram illustrating an example method for detecting malicious transactions using multi-level risk analysis, according to some embodiments.

FIG. 4 is a flow diagram illustrating an example method for applying merchant-specific fraud-detection rules to a transaction request, according to some embodiments.

FIG. 5 is a block diagram illustrating an example user interface that may be used to view and modify various settings for a merchant-specific fraud-detection service, according to some embodiments.

FIG. 6 is a block diagram illustrating an example computer system, according to some embodiments.

### DETAILED DESCRIPTION

Server computer systems may provide computing resources and services to various end users. For example, an online payment server system may provide an online payment service that enables users to perform financial transactions, such as transferring money to individuals or to merchants. In some embodiments, the online payment service may be used by merchant transaction systems to facilitate online payments from various users to purchase goods or services. In some instances, however, malicious third-parties may attempt fraudulent transactions using the online payment service.

To limit the instances of fraudulent transactions performed via its system, the online payment service may perform a risk-assessment prior to processing a transaction. This risk-assessment may be performed to detect and prevent potentially fraudulent transactions attempted on the online payment system. As noted above, for example, the online payment system may block a transaction in which the risk-assessment indicates that the level of risk associated with the transaction exceeds some predetermined threshold value. In such prior systems, the transaction would not be processed and, while the online payment service would avoid the cost of the potentially fraudulent transaction, the associated merchant transaction system would lose the benefit of a potentially legitimate transaction. In some instances, the merchant transaction system for which a transaction is being performed may have a higher risk tolerance than the online payment service and may wish to perform further risk-assessment operations for the transaction prior to its rejection.

In various embodiments, the disclosed systems and methods may address these or other technical problems by detecting malicious transactions using multi-level risk analysis. For example, in some embodiments, an online payment system may receive a transaction requests associated with the merchant. The online payment system may then perform, using a risk-assessment module, an initial risk-assessment to generate a risk score for the transaction. In various embodiments, this initial risk-assessment is a merchant-neutral risk-assessment procedure applied for transactions associated with multiple merchants. The online payment system may then determine, based on the risk score, whether the transaction has passed this initial risk-assessment. If the transaction does not pass the initial risk-assessment, the online payment system may then determine whether the merchant has enabled a risk-assessment override option. If so, the online payment system may perform, using a fraud-detection module, various merchant-specific fraud-detection operations. For example, in some embodiments, the fraud-detection module may retrieve a merchant-specific fraud-detection rule associated with the merchant. It may then apply the merchant-specific fraud-detection rule to transaction data associated with the transaction and, based on an outcome of the merchant-specific risk-assessment, determine whether to authorize the transaction.

Thus, in various embodiments, the disclosed systems and methods use multi-level risk analysis to detect malicious transactions, allowing the merchant transaction systems to override the initial risk-assessments based on their individual risk-tolerance while still identifying and preventing malicious transactions attempted on the online payment system.

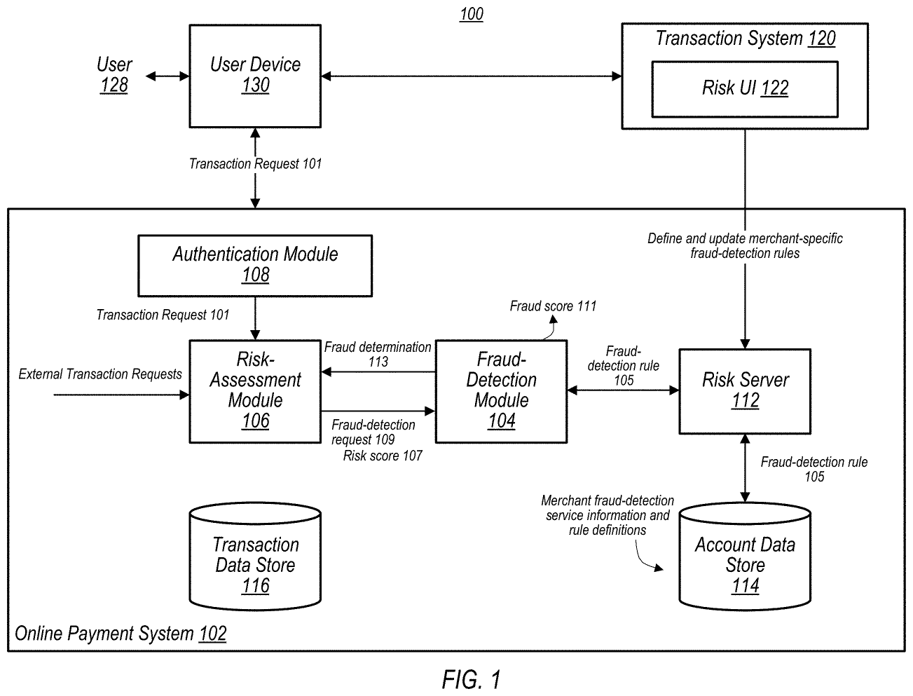

Referring now to FIG. 1, a block diagram illustrating a system 100 for detecting malicious transactions using multi-level risk analysis is shown, according to some embodiments. In the embodiment of FIG. 1, system 100 includes a portion of an online payment system 102, a transaction system 120, and a user device 130. Note that, although shown in direct communication, one or more of online payment system 102, transaction system 120, and user device 130 may be connected via one or more communication networks (not shown for clarity).

In various embodiments, transaction system 120 provides a web service accessible to various remote users 128 via one or more communication networks. For example, in various embodiments, transaction system 120 may host a streaming service, an online retail store, an email service, or any other suitable web service. In the following discussion, reference will be made to embodiments in which the transaction system 120 is an online merchant that offers various products or services to remote users 128. Note, however, that this embodiment is provided merely as an example and is not intended to limit the scope of the present disclosure. In other embodiments, the disclosed systems and methods may be implemented in the context of any other suitable web service.

In various embodiments, the merchant transaction system 120 may use the online payment system 102 to facilitate online payments made by various users 128 to purchase its goods or services. For example, when completing a purchase with the merchant transaction system 120, the user 128 may elect to provide funds via an online payment service provided by online payment system 102. The user device 130 may then be redirected to a webpage associated with the online payment system 102 to provide authorization and financial information to fund the transaction. Note, that in some embodiments, the user 128 may have an existing account with the online payment system 102. In such embodiments, the online payment system 102 may use existing account information (e.g., bank account information, credit card information, authentication credentials, phone number, email address, etc.) associated with the user 128 to facilitate the requested transaction. For example, once a requesting user 128 has been authenticated to the online payment system 102 and the transaction request 101 has passed the multi-level risk assessment, the online payment system 102 may utilize account information previously provided by the user 128 to facilitate the transaction with the transaction system 120, according to some embodiments. In various embodiments, however, the user 128 is not required to have an existing account with online payment system 102 to submit a payment to merchant transaction system 120. For example, in some embodiments, the user 128 may submit such a payment as a “guest” by providing the requisite financial information (e.g., bank account information, credit card information, etc.) as part of the transaction request 101. As a non-limiting example, the user 128 may provide this financial information through a form on the webpage associated with the online payment system 102. The online payment system 102 may then use this provided financial information to facilitate the transaction with transaction system 102 (e.g., after the transaction request 101 has passed the multi-level risk assessment).

Note that, in some embodiments, online payment system 102 is operable to facilitate payment for transactions in instances in which the user device 130 does not send a transaction request directly to the online payment system 102. For example, as shown in FIG. 1, online payment system 102 may process external transaction request that were not sent directly to the system 102 by the user device 130 or the transaction system 120. As a non-limiting example, in some instances the user 128 may initiate payment through an alternate payment platform, such as Braintree™, that is operable to process payments from various payment sources, such as credit cards, debit cards, Venmo™, Apple Pay™, Android Pay™, etc. In some such embodiments, the alternate payment platform may utilize the online payment system 102 to facilitate the transaction by performing various risk-assessment operations. As shown in FIG. 1, for example, the risk-assessment module 106 receives an external transaction request from an alternate payment platform. As with the transaction request 101, the online payment system 102 may utilize multi-level risk analysis to determine whether the external transaction request is malicious.

In the embodiment of FIG. 1, online payment system 102 receives a transaction request 101 from user device 130 to facilitate the transaction with merchant transaction system 120. As shown in FIG. 1, online payment system 102 includes authentication module 108, which, in various embodiments, is operable to perform various user authentication operations in response to the transaction requests 101. In some embodiments, for example, the authentication module 108 may require the requesting user 128 to provide valid authentication credentials (e.g. a username and password) or perform various multi-factor authentication operations, such as providing a one-time passcode sent to an email account associated with the user 128.

As shown in FIG. 1, online payment system 102 includes both risk-assessment module 106 and fraud-detection module 104. In various embodiments, modules 106 and 104 may be used to detect malicious transactions using a multi-level risk analysis. For example, once the user 128 has been authenticated to the online payment system 102, the transaction request 101 may be forwarded to the risk-assessment module 106. In various embodiments, the risk-assessment module 106 is operable to perform an initial risk-assessment for the transaction request 101. This initial risk-assessment, in various embodiments, is a merchant-neutral risk-assessment procedure that is applied for transactions associated with multiple merchant transaction systems 120. For example, in some embodiments, the risk-assessment module 106 may apply the same initial risk-assessment for all transaction requests that it receives, regardless of the merchant transaction system 120 with which the transaction requests are associated. Risk-assessment module 106 may perform the initial risk-assessment based on various criteria associated with the transaction request 101. As non-limiting examples, the risk-assessment module 106 may perform the initial risk-assessment based on any one or more of: the origin IP address of the transaction request 101, number of transactions requested by the user device 130 in a given time period (e.g., one hour, one minute, etc.), location of the requesting user device 130, identity of the merchant transaction system 120, value of the transaction, goods or services included in the transaction, or any other suitable attribute of the transaction request 101, the requesting user 128, the user device 130, or the merchant transaction system 120.

In various embodiments, the risk-assessment module 106 may generate a risk score 107 for the transaction based on this initial risk-assessment. The risk score 107 may take any of various formats suitable to indicate a degree of risk associated with the transaction as determined through the initial risk-assessment. For example, in some embodiments, the risk score 107 may be provided as a number on a scale (e.g. from 1 to 100, 1 to 5, etc.) in which increasing values indicate an increased risk that the transaction is malicious. In other embodiments, for example, the risk score 107 may be provided as a classification of either low-, medium-, or high-risk. In still other embodiments, the risk score 107 may simply be provided as a pass/fail value, as a percentage over a threshold value, etc. Note, however, that the above embodiments are provided merely as examples and are not intended to limit the scope of the present disclosure. In other embodiments, the risk score 107 may be provided in any other suitable format.

In the depicted embodiment, online payment system 102 further includes fraud-detection module 104, which, in various embodiments, is operable to implement merchant-specific fraud-detection rules for transaction requests received by the online payment system 102. For example, after performing the initial risk-assessment, the risk-assessment module 106 may send a fraud-detection request 109 (e.g. as application programming interface (“API”) call) to the fraud-detection module 104 to determine whether any merchant-specific fraud-detection operations should be performed for the transaction request 101. In various embodiments, the fraud-detection module 104 may provide a customizable fraud-detection service that individual merchant transaction systems 120 may elect to use on top of (that is, in addition to) the initial risk-assessment performed by risk-assessment module 106. For instance, as shown in FIG. 1, transaction system 120 may access a risk user interface 122 (e.g. via a web browser) that may be used to customize the fraud-detection service for the merchant transaction system 120. For example, in some embodiments, the transaction system 120 may use the risk UI 122 to enable the fraud detection service, to define and update merchant-specific fraud-detection rules, view historical performance information for the merchant-specific fraud-detection rules, receive and review suggested updates to fraud-detection rules, and perform other operations associated with the merchant-specific fraud-detection service provided by fraud-detection module 104. In various embodiments, this information may be stored, for example, in account data store 114 that is included in (or accessible to) the online payment system 102. When the fraud-detection module 104 receives the fraud-detection request 109, it may access this account information (e.g. via risk server 112) to determine whether the fraud detection service is enabled for the merchant.

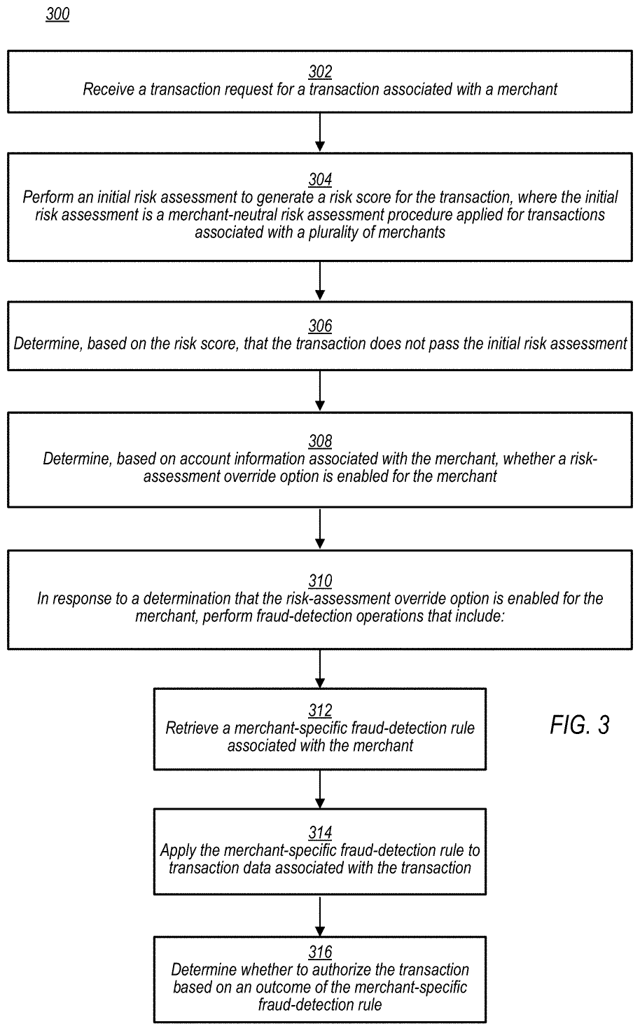

As noted above, in some instances, the merchant transaction system 120 may have a risk tolerance that is higher than that of the online payment system 102. As such, the merchant transaction system 120 may wish to perform additional risk-assessment operations, in addition to the initial risk-assessment, before rejecting a transaction request 101. In various embodiments, the merchant transaction system 120 may elect to enable a risk-assessment override option (e.g. using the risk UI 122) that triggers fraud-detection module 104 to perform additional risk-assessment operations. As explained in more detail below with reference to FIG. 3, the risk-assessment override option may be either a binary option (e.g., either enabled or disabled for all transactions associated with the merchant transaction system 120) or an option that is conditionally enabled or disabled for the merchant transaction system 120 based on the characteristics of the transaction request 101.

If the risk-assessment override option is not enabled for the merchant transaction system 120, the fraud-detection module 104 may send, to risk-assessment module 106, a response indicating that no merchant-specific fraud-detection operations are to be performed for the transaction request 101. In some such embodiments, online payment system 102 may determine whether to authorize the transaction request 101 on the basis of the initial risk-assessment. If, however, the risk-assessment override option is enabled for the merchant transaction system 120, the fraud-detection module 104 may then retrieve, via the risk server 112, one or more merchant-specific fraud-detection rules 105 from the account data store 114. Note that, in various embodiments, account data store 114 and transaction data store 116 may be implemented using any of various suitable data storage or management services, including one or more of Apache Druid™, MySQL™, Redis™, etc.

In various embodiments, a merchant-specific fraud-detection rule 105 is a rule specified by the merchant transaction system 120 to detect transactions that are fraudulent or otherwise malicious. For example, in some embodiments, the fraud-detection rule 105 is a “handwritten” rule that specifies one or more evaluation criteria (e.g. the number of transactions attempted from a single IP address) and one or more corresponding threshold values (e.g. 10 transactions attempted from the single IP address). In various embodiments, the merchant transaction system 120 may specify multiple fraud-detection rules 105 to be applied to transaction requests received by the online payment system 102 for merchant transaction system 120. Further, as discussed in more detail below with reference to FIG. 3, in some embodiments, the fraud-detection module 104 is operable to use one or more machine learning algorithms to tune the merchant-specific fraud-detection rules 105 to increase their efficacy. In other embodiments, one or more of the merchant-specific fraud-detection rules 105 may utilize a trained machine learning model (e.g. an autoencoder model trained using transaction data associated with the merchant transaction system 120) to detect fraudulent transactions. Note, however, that these embodiments are provided merely as examples and, in other embodiments, the merchant-specific fraud-detection rules 105 may utilize any other suitable approach for detecting malicious transactions.

Once it has retrieved the one or more merchant-specific fraud-detection rule(s) 105, the fraud-detection module 104 may apply these rules 105 to generate a fraud score 111 for the transaction request 101, as described in more detail below with reference to FIG. 3. As a non-limiting example, the fraud-detection module 104 may apply each of the one or more merchant-specific fraud-detection rules 105 to transaction data for the transaction request 101. The outcome for each of the fraud-detection rules 105, in some such embodiments, may be a numerical value that may contribute to the fraud score 111. For example, the fraud score 111 may be calculated as the cumulative sum of the outcome of each of the one or more fraud-detection rules 105. Note, however, that this embodiment is provided merely as a non-limiting example. In other embodiments, the fraud score 111 may be computed using any other suitable means. For example, in some embodiments, the fraud score 111 may be calculated as an average of the outcome of each of the fraud-detection rules 105, as a weighted sum of the outcome of the fraud-detection rules 105, etc. In various embodiments, the fraud-detection module 104 may use this fraud score 111 to generate a fraud determination 113. In some embodiments, the fraud-detection module 104 may determine whether to authorize the transaction request 101 based on the fraud score 111. In some such embodiments, the fraud determination 113 may then specify whether the transaction request 101 should be authorized. In other embodiments, however, the fraud determination 113 sent the to the risk-assessment module 106 may instead include the fraud score 111, which the risk-assessment module 106 may use to determine whether to authorize the transaction request 101. Note that, in some embodiments, rather than immediately denying the transaction request 101 if it fails either the initial risk-assessment or the merchant-specific risk-assessment performed by the fraud-detection module 104, the online payment system 102 may instead take one or more corrective actions, such as requiring the requesting user 128 to perform an additional layer of authentication, flagging the transaction request 101 for manual review, etc.

In various embodiments, if the online payment system 102 determines that the transaction request 101 should be authorized, it may then proceed with further operations to facilitate the transaction. If, however, even after these additional merchant-specific risk-assessment operations have been performed, the online payment system 102 determines that the transaction request 101 should still be denied, the online payment system 102 may take appropriate corrective actions to deny the transaction request, according to various embodiments.

Thus, in various embodiments, the disclosed systems and methods use a multi-level risk-analysis to detect malicious transactions attempted via the online payment system 102. In instances in which a given merchant transaction system 120 has a higher risk-tolerance than the online payment system 102, the merchant transaction system 120 may override the initial risk-assessment performed (e.g. by default) by the online payment system 102 and elect to apply one or more merchant-specific fraud-detection rules 105. The merchant transaction system 120 may use the outcome of this merchant-specific risk-assessment to determine whether it would like to authorize the transaction request 101, despite the fact that it has failed the initial risk-assessment performed by risk-assessment module 106. In some embodiments, the merchant-specific fraud-detection rules 105 may be better suited for detecting malicious transactions for a given merchant and, as such, more successful in preventing malicious transactions performed via online payment system 102 than the initial risk-assessment alone. For example, as noted above, the merchant-specific risk-assessment may utilize one or more machine learning models that were trained by analyzing large datasets of transaction data for the transaction system 120 to identify specific trends that would often be overlooked by human analysts. As such, the machine learning models, and fraud-detection rules 105 established or refined based on these models, applied during the merchant-specific risk-analysis may be more effective at detecting a malicious transaction associated with a merchant transaction system 120 than the merchant-neutral initial risk-assessment. Accordingly, in various embodiments, the disclosed systems and methods provide transaction system 120 with greater control over the risk-assessment operations performed by the online payment system 102 while reducing the number of malicious transactions performed on the online payment system 102, thereby improving the functioning of the system as a whole.

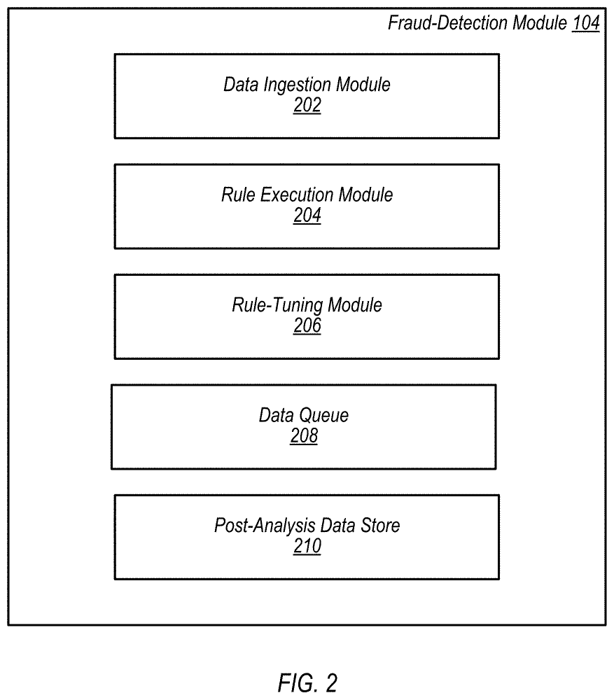

Turning now to FIG. 2, a block diagram of an example fraud-detection module 104 is depicted, according to some embodiments. In various embodiments, fraud-detection module 104 is operable to perform a merchant-specific risk-assessment for transaction requests by applying one or more merchant-specific fraud-detection rules 105.

Fraud-detection module 104 includes data ingestion module 202, which, in various embodiments, is operable to receive fraud-detection requests (such as fraud-detection request 109 of FIG. 1) from risk-assessment module 106. In various embodiments, the data ingestion module 202 is operable to analyze and validate the transaction data included in the fraud-detection request 109. For example, in some embodiments, fraud-detection request 109 includes various items of transaction data associated with the transaction request 101. As a non-limiting example, this transaction data may include: an identifier for the merchant transaction system 120, an identifier for the user 128 or user device 130, the origin IP address of the user device 130, the transaction value, the risk score 107, or any other suitable transaction data that may be used by the fraud-detection module 104 to detect fraudulent activity.

In FIG. 2, fraud-detection module 104 further includes rule execution module 204, which, in various embodiments, is operable to retrieve and execute one or more merchant-specific fraud-detection rules 105. For example, as discussed above with reference to FIG. 1, fraud-detection module 104 may receive a fraud-detection request 109 from the risk-assessment module 106. In response to this fraud-detection request 109, in various embodiment, the rule execution module 204 may determine, based on account information associated with the merchant transaction system 120, whether the merchant-specific risk-assessment service is enabled for the transaction system 120 and whether a risk-assessment override option is enabled for the merchant transaction system 120. For example, in some embodiments, the rule execution module 204 is operable to analyze the information included in the fraud-detection request 109, such as the risk score 107, to determine whether the transaction request has passed the initial risk-assessment. If so, the rule execution module 204 may retrieve (e.g., via risk server 112) one or more merchant-specific fraud-detection rules 105 from the account data store 114. Once retrieved, the rule execution module 204 may apply these one or more merchant-specific fraud-detection rules 105 to the transaction data included in the fraud-detection request 109, according to various embodiments. In some embodiments, rule execution module 204 may further utilize data stored in the transaction data store 116 to apply the one or more merchant-specific fraud-detection rules 105. As a non-limiting example, a fraud-detection rule 105 may use, as one of the evaluation criteria used to evaluate the transaction request 101, the number of transactions attempted from a single IP address during a given time period (e.g., one day). In such an embodiment, the fraud-detection module 104 may retrieve this information from transaction data store 116 and use it to apply the fraud-detection rule 105. As described in more detail below with reference to FIG. 3, the rule execution module 204, in various embodiments, may then generate a fraud score 111 based on the outcome of these one or more merchant-specific fraud-detection rules 105, and, based on this fraud score 111, may generate a fraud determination 113.

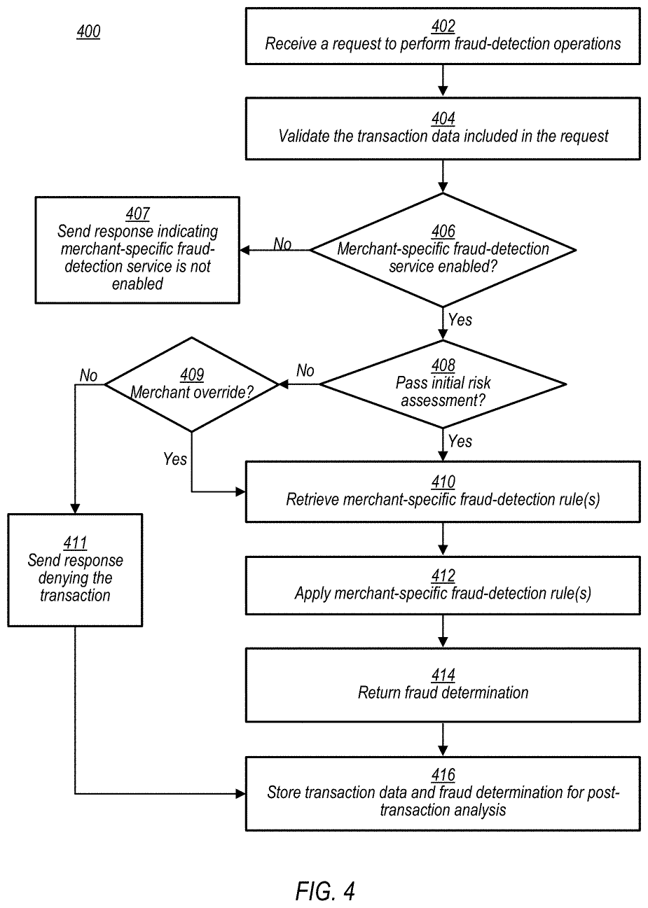

Fraud-detection module 104, in the illustrated embodiment, further includes rule-tuning module 206, which, as described in more detail below with reference to FIG. 4, is operable to perform tuning operations to tune one or more of the merchant-specific fraud-detection rules 105. For example, in some embodiments, the rule-tuning module 206 may use historic transaction data associated with the merchant transaction system 120 to train a machine learning model, such as a decision tree. As will be appreciated by one of skill in the art with the benefit of this disclosure, “training” a machine learning model refers generally to the process of providing a machine learning algorithm with a training dataset from which the algorithm may learn patterns that map input variables associated with an observation (e.g., origin IP address) to a particular output (e.g., a classification as either fraudulent or not fraudulent, in the present example). Once trained, the machine learning model may be used by the rule-tuning module 206 to tune one or more the fraud-detection rules 105 in an effort to improve their efficacy. For example, in an embodiment in which a merchant-specific fraud-detection rule 105 includes an evaluation criterion and a corresponding threshold value, the rule-tuning module 206 may use the trained machine learning model to generated updated threshold value for that evaluation criterion. If this updated threshold value improves the performance of the merchant-specific fraud-detection rule 105, the online payment system 102 may suggest (e.g. via the risk UI 122) this updated version of the rule 105 to the merchant transaction system 120. If accepted by the merchant transaction system 120, the fraud-detection module 104 may update a rule definition for this fraud-detection rule 105 stored in the account data store 114 to reflect the changes suggested by the machine learning model.

Further, in FIG. 2, fraud-detection module 104 includes data queue 208 and post-analysis data store 210. In various embodiments, data queue 208 and post-analysis data store 210 may be used to store transaction and fraud-determination data for subsequent use by the rule-tuning module 206. For example, in some embodiments, the fraud-detection module 104 may use the post-analysis data store 210 to store the transaction data received in the fraud-detection request 109, any additional transaction data used to apply the merchant-specific fraud-detection rules 105 (e.g., stored in the transaction data store 116 of FIG. 1), the outcome of the fraud-detection rules 105, the calculated fraud score 111 for a transaction request 101, the ultimate fraud determination 113, etc. This data may then be used by the rule-tuning module 206 when generating suggested updates to one or more of the merchant-specific fraud-detection rules 105, according to various embodiments. Note that, in some embodiments, data queue 208 or post-analysis data store 210 may be implemented as part of the account data store 114 or transaction data store 116.

In various embodiments, fraud-detection module 104 may use the data queue 208 as a temporary storage until the transaction and fraud-determination data may be asynchronously stored in post-analysis data store 210. For example, in various embodiments, such a use of the data queue 208 may improve scaling for the fraud-detection module 104 by enabling the fraud-detection module 104 to better respond to spikes in data traffic. Further, in some embodiments, data queue 208 may be used to store data for a given transaction request 101 until that request has been resolved, at which time the data stored in data queue 208 may be populated to the transaction data store 116, account data store 114, post-analysis data store 210, etc. Data queue 208 and post-analysis data store 210 may be implemented using any of various suitable data storage services. As a non-limiting example, in some embodiments, data queue 208 may be implemented using Apache Kafka™ and post-analysis data store 210 may be implemented using Apache Druid™. Note, however, that these embodiment are provided merely examples and, in other embodiments, any suitable data storage service may be used.

Referring now to FIG. 3, a flow diagram illustrating an example method 300 for detecting malicious transactions using multi-level risk analysis is depicted, according to some embodiments. In various embodiments, method 300 may be performed by online payment system 102 of FIG. 1 to determine whether to authorize a transaction request 101 associated with a merchant transaction system 120. For example, online payment system 102 may include (or have access to) a non-transitory, computer-readable medium having program instructions stored thereon that are executable by the online payment system 102 to cause the operations described with reference to FIG. 3. In FIG. 3, method 300 includes elements 302-316. While these elements are shown in a particular order for ease of understanding, other orders may be used. In various embodiments, some of the method elements may be performed concurrently, in a different order than shown, or may be omitted. Additional method elements may also be performed as desired.

At 302, in the illustrated embodiment, the online payment system receives a transaction request for a transaction associated with a merchant. For example, with reference to FIG. 1, online payment system 102 may receive a transaction request 101 from user device 130 for a transaction associated with transaction system 120.

At 304, in the illustrated embodiment, the online payment system performs (e.g., using risk-assessment module 106) an initial risk-assessment to generate a risk score for the transaction. In some embodiments, the initial risk-assessment is a merchant-neutral risk-assessment procedure applied for transactions associated with a plurality of merchants. For example, in some embodiments, risk-assessment module 106 may perform the same initial risk-assessment for all merchants, for all merchants within a given industry, for all transactions exceeding a certain value, etc. Risk-assessment module 106 may perform the initial risk-assessment based on various criteria associated with the requested transaction, such as the origin IP address, number of transactions requested by the requesting user in a given time period (e.g., one hour, one minute, etc.), location of the requesting user, value of the transaction, goods or services included in the transaction, etc.

In various embodiments, risk-assessment module 106 may generate a risk score 107 for the transaction based on this initial risk-assessment, which may then be used to determine whether the transaction passes this initial risk-assessment. As noted above, the risk score 107 may be generated in various formats. As non-limiting examples, risk score 107 may be provided as a number on a scale (e.g., from 1-10, 0.0-1.0, 1-3, etc.), as a classification of low-, medium-, and high-risk, as a simple pass/fail, or in any other format suitable to indicate the degree of risk associated with the transaction as determined through the initial risk-assessment. In various embodiments, the risk-assessment module 106 may determine whether the transaction passes the initial risk-assessment, for example, based on whether the risk score 107 exceeds a certain threshold. The nature of this threshold will vary depending on the format of the risk score 107. For example, in an embodiment in which the risk score is expressed on a scale from 1-10 (with increasing numbers indicating an increased degree of risk for the transaction), risk-assessment module 106 may determine that the transaction passes the initial risk-assessment if the risk score 107 is below a seven. In embodiments in which the risk score 107 is provided as a classification of low-, medium-, or high-risk, for example, risk-assessment module 106 may determine that the transaction passes the initial risk-assessment if the risk score is “low-risk.” Note, however, that these embodiments are provided merely as examples and, in other embodiments, the risk-assessment module 106 may use any suitable threshold in determining whether the transaction passes or fails the initial risk-assessment based on the risk score 107.

At 306, in the illustrated embodiment, the risk-assessment module 106 determines that the transaction does not pass the initial risk-assessment based on the risk score 107. Continuing with an example above, assume that the risk-assessment module 106 generates a risk score 107 of 8 on a scale from 1-10 and, on this basis, the risk-assessment module 106 determines that the transaction does not pass the initial risk-assessment. In some embodiments, such as the embodiment depicted in FIG. 1, the risk-assessment module 106 may then send a merchant-specific fraud-detection request 109, including the risk score 107, to fraud-detection module 104.

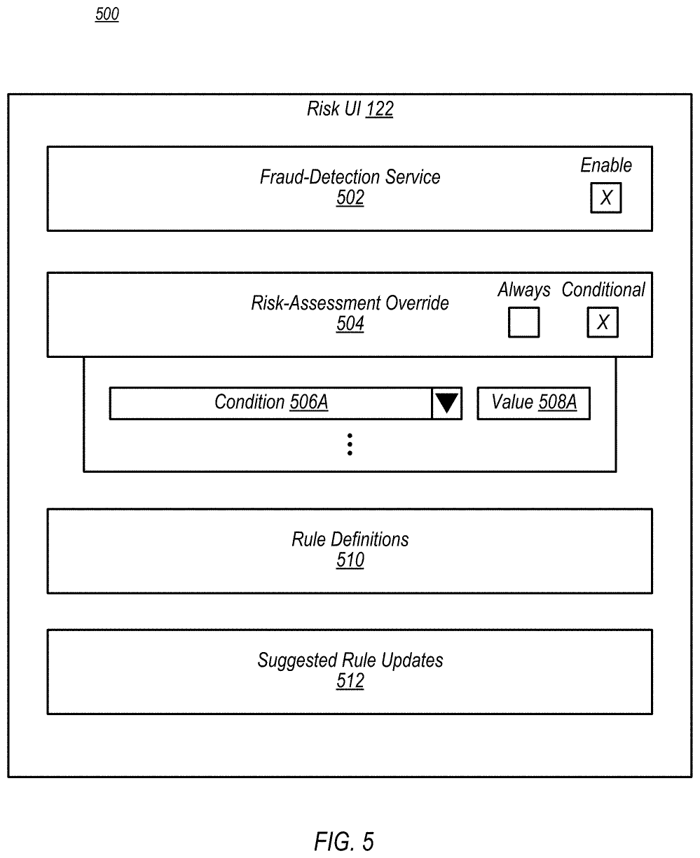

At 308, in the illustrated embodiment, the online payment system determines whether a risk-assessment override option is enabled for the merchant. In various embodiments, the determination in element 308 is performed based on account information associated with the merchant. For example, account data store 114 of FIG. 1 may store account information associated with the merchant transaction system 120 specifying whether the risk-assessment override option is enabled. In some embodiments, the risk-assessment override may be a binary option in which the override is either enabled or disabled. In other embodiments, however, the risk-assessment override may be an option that is conditionally enabled or disabled based on the characteristics of the transaction being evaluated or the risk score 107. For example, in some embodiments, the account information may specify that, for transactions in which the transaction value is below a predetermined threshold (e.g., $1, $5, $20, etc.), the risk-assessment override is enabled, but for transactions in which the transaction value matches or exceeds that predetermined threshold value, the risk-assessment override is disabled. Further, in some embodiments, the account information may specify that, for transactions in which the risk score 107 matches or is below a predetermined threshold (e.g., below a 9 of 10, a classification as low- or medium-risk, etc.) the risk-assessment override option is enabled but for transactions in which the risk score exceeds that predetermined threshold value, the risk-assessment override is disabled. Note that, in some embodiments, the risk-assessment override may be conditionally enabled based on multiple factors, such as both the transaction value and the risk score 107. Additionally, note that, in various embodiments, the merchant may assign and modify the predetermined threshold value(s) used to conditionally enable or disable the risk-assessment override. For example, as described in more detail below with reference to FIG. 5, the merchant may use the risk UI 122 to adjust the account information, including information associated with the risk-assessment override option. Note that, in some embodiments, the transaction system 120 may elect to enable the fraud-detection module 104 to perform additional risk-assessment operations only for transactions that fail the initial risk-assessment, only for transactions that pass the initial risk-assessment, or for all transactions regardless of the result of the initial risk-assessment. Further note that, in some embodiments, by electing to override the initial risk-assessment performed by the risk-assessment module 106, the transaction system 120 may agree to accept responsibility for the transaction if it does, in fact, turn out to be malicious and was authorized at the merchant transaction system 120's directive.

At 310, in the illustrated embodiment, the online payment system 102 (e.g., using fraud-detection module 104) performs fraud-detection operations in response to a determination that the risk-assessment override option is enabled for the merchant. In some embodiments, the fraud-detection operations include the functionality described with reference to elements 312-316. Note, however, that additional or fewer fraud-detection operations may be performed as desired, according to various embodiments. Further note that, in response to a determination that the risk-assessment override option is disabled, the online payment system may deny the transaction rather than performing any merchant-specific fraud-detection operations for the transaction. For example, the fraud-detection module 104 may check the account information for the merchant and determine that the risk-assessment override option is disabled. The fraud-detection module 104 may then return an indication of this status to the risk-assessment module 106, which may deny the transaction on the basis of the initial risk-assessment.

At 312, in the illustrated embodiment, the fraud-detection module 104 retrieves a merchant-specific fraud-detection rule associated with the merchant. For example, as shown in FIG. 1, fraud-detection module 104 may retrieve a merchant-specific fraud-detection rule 105 from the account data store 114 using risk server 112. At 314, in the illustrated embodiment, the fraud-detection module 104 applies the merchant-specific fraud-detection rule 105 to transaction data associated with the transaction. As noted above, in various embodiments, the fraud-detection request 109 may include various items of transaction data that may be used, by fraud-detection module 104, when applying the fraud-detection rules 105. Further note that, in some embodiments, one or more of the merchant-specific fraud-detection rules 105 may use the risk score 107 as an input. For example, in some embodiments, a given merchant-specific fraud-detection rule 105 may include one (of potentially multiple) evaluation criterion that checks whether the risk score 107 is below a particular threshold value (e.g., less than a 9 on a scale from 1-10). If the risk score 107 for a given transaction is below that threshold value, the given rule 105 will impact the fraud score 111 such that it is more likely that the transaction request 101 is authorized, for example. If the risk score 107 for the given transaction matches or exceeds that threshold value, however, the given rule 105 will impact the fraud score 111 such that it is less likely that the transaction request 101 will be authorized by the online payment system 102. Note, however, that the above embodiment is provided merely as an example and is not intended to limit the scope of the present disclosure.

At 316, in the illustrated embodiment, the fraud-detection module 104 determines whether to authorize the transaction based on an outcome of the merchant-specific fraud-detection operations. Note that, in some embodiments, the merchant may have defined multiple merchant-specific fraud-detection rules 105 and, in such embodiments, the fraud-detection module 104 may retrieve and apply multiple merchant-specific fraud-detection rules 105 for the transaction. Further note that, as described above, fraud-detection module 104 may generate a fraud score 111 for the transaction based on the one or more merchant-specific fraud-detection rules 105. In some embodiments, the fraud score 111 is a value that indicates the probability that the transaction is fraudulent based on the outcome of one or more of the fraud-detection rules 105. In some embodiments, the fraud score 111 may be provided as a value within a range. As a non-limiting example, the fraud score 111 may be provided as a value within the range of −100 to +100, with lower numbers indicating a higher probability that the transaction is fraudulent. For embodiments in which there are multiple merchant-specific fraud-detection rules 105, each of the rules 105 may contribute to the fraud score 111. For example, fraud-detection module 104 may apply a first merchant-specific fraud-detection rule 105 to transaction data associated with the transaction and generate an output (e.g., −2). The fraud-detection module 104 may then apply the remaining merchant-specific fraud-detection rules 105, each of which may similarly generate an output. The fraud-detection module 104 may then generate the fraud score 111 as a cumulative sum of the outputs for each of the merchant-specific fraud-detection rules 105 applied.

The fraud-detection module 104 may then determine whether to authorize the transaction based on the fraud score 111, according to various embodiments. For example, if the fraud-detection module 104 determines that, based on the fraud score 111, the transaction request 101 should be authorized, the fraud-detection module 104 may return a fraud determination 113 to the risk-assessment module 106 indicating this result. In such embodiments, the online payment system 102 may then take further actions to process the transaction request 101. If, however, the fraud-detection module 104 determines that, based on the fraud score 111, the transaction request 101 should not be authorized, the online payment system 102 may take any of various suitable corrective actions (e.g., returning a fraud determination 113 indicating that the transaction request 101 should be denied, requiring the user 128 to perform additional authentication operations, etc.).

Referring now to FIG. 4, a flow diagram illustrating an example method 400 for applying merchant-specific fraud-detection rules is depicted, according to some embodiments. In various embodiments, method 400 may be performed by fraud-detection module 104 of FIG. 1 to determine whether to authorize a transaction after the risk-assessment module 104 has performed an initial risk-assessment. For example, fraud-detection module 104 may include (or have access to) a non-transitory, computer-readable medium having program instructions stored thereon that are executable by the online payment system 102 to cause the operations described with reference to FIG. 4. In FIG. 4, method 400 includes elements 402-416. While these elements are shown in a particular order for ease of understanding, other orders may be used. In various embodiments, some of the method elements may be performed concurrently, in a different order than shown, or may be omitted. Additional method elements may also be performed as desired.

At 402, in the illustrated embodiment, the fraud-detection module 104 receives a request to perform fraud-detection operations. For example, in the embodiment of FIG. 1, fraud-detection module 104 receives a fraud-detection request 109 from risk-assessment module 106. The fraud-detection request 109 may include various items of information corresponding to the transaction. For example, in some embodiments, the fraud-detection request 109 may include a risk score 107, a merchant identifier, transaction data associated with the transaction, etc. At 404, in the illustrated embodiment, the fraud-detection module 104 validates the transaction data included in the fraud-detection request 109. For example, the fraud-detection module 104 may verify that the correct dataset is provided by the risk-assessment module 106, that the data includes the correct fields, dates, no data is missing, etc.

At 406, in the illustrated embodiment, the fraud-detection module 104 determines whether the merchant-specific fraud-detection service is enabled. In various embodiments, fraud-detection module 104 may determine whether the merchant-specific fraud-detection service is enabled based on the account information stored in account data store 114. For example, in some embodiments, some merchant transaction systems 120 may not utilize the merchant-specific fraud-detection service provided by fraud-detection module 104 and, as such, the account information for those merchants will indicate that the fraud-detection service is not enabled. In such embodiments, method 400 proceeds to element 407, in which the fraud-detection module 104 sends a response to risk-assessment module 106 indicating that the merchant-specific fraud-detection service is not enabled for the merchant. In various embodiments, the online payment system 102 may then determine whether to authorize the transaction request 101 on the basis of the initial risk-assessment.

In the depicted embodiment, if the merchant has enabled the merchant-specific fraud-detection service at element 406, method 400 proceeds to element 408. At 408, in the illustrated embodiment, the fraud-detection module 104 determines whether the transaction has passed the initial risk-assessment performed by risk-assessment module 106. In some embodiments, fraud-detection module 104 may determine whether the transaction passed the initial risk-assessment based on the risk score 107. In other embodiments, however, the risk-assessment module 106 may instead send (e.g., instead of or in addition to the risk score 107) an indication of whether the transaction passed the initial risk-assessment.

If the transaction did pass the initial risk-assessment, method 400 proceeds to element 410. If, however, the transaction did not pass the initial risk-assessment, method 400 proceeds to element 409 in which the fraud-detection module 104 determines whether a risk-assessment override option is enabled for the merchant. As noted above, the determination at element 409 may be performed based on account information associated with the merchant. In some embodiments, account data store 114 may store account information indicating whether the risk-assessment override option is enabled for the merchant transaction system 120. For example, in some embodiments, a merchant may use the risk UI 122 to specify its preferences for the risk-assessment override option. As noted above, the risk-assessment override option may either be a binary option (that is, either on for all transactions or off for all transactions) or a conditional option based on conditions selected by the merchant transaction system 120.

In various embodiments, the merchant may establish conditions based on various attributes associated with the transaction. For example, in some embodiments, the merchant may establish one or more conditions based on the transaction value of the transaction. As one non-limiting example, the merchant may establish that the risk-assessment override option is enabled for transactions in which the transaction value is below the predetermined threshold value (e.g. $10.00) and is disabled if the transaction value matches or exceeds that threshold value. In other embodiments, the merchant may establish one or more conditions based on the risk score 107 generated by the risk-assessment module 106 during the initial risk-assessment. As one non-limiting example, the merchant may specify that the risk-assessment override option is enabled for transactions in which the risk score 107 generated during the initial risk-assessment is below a predetermined threshold, but is disabled for transactions in which the risk score 107 matches or exceeds that predetermined threshold. In still other embodiments, the merchant may establish conditions based on any suitable combination of transaction attributes. For example, in some embodiments, the merchant may establish one or more conditions based on both of the transaction value and the risk score for a transaction. As a non-limiting example, the merchant may establish a condition that states that the risk-assessment override option is enabled for transactions in which the risks score exceeds a predetermined risk threshold if the transaction value is still below a transaction value threshold. Note, however, that the above embodiments are provided merely as examples and are not intended to limit the scope of the present disclosure. In other embodiments, various other suitable conditions may be used.

If the risk-assessment override option is not enabled for the merchant, method 400 proceeds to element 411, in which the fraud-detection module 104 sends a response to the risk-assessment module 106 indicating that the risk-assessment override option is not enabled, and that the transaction should be denied, according to the depicted embodiment. If, however, the risk-assessment override option is enabled for the merchant for the transaction, method 400 proceeds to the elements 410 in which the fraud-detection module 104 retrieves one or more merchant-specific fraud-detection rules 105 from the account data store 114. Method 400 and then proceeds to element 412, in which the fraud-detection module 104 applies the merchant-specific fraud-detection rules 105 to transaction data associated with the transaction request 101. As noted above, in some embodiments, the one or more merchant-specific fraud-detection rules 105 may be used to generate a fraud score 111 that is indicative of the probability that the requested transaction is fraudulent. In some such embodiments, element 412 includes applying each of the one or more merchant-specific fraud-detection rules 105 to the transaction data to generate the fraud score 111 for the transaction. Further, in some embodiments, the fraud-detection module 104 may utilize the risk score 107 in one or more of the merchant-specific fraud-detection rules, allowing the online payment system to leverage the outcome of the initial, merchant-neutral risk-assessment when performing the merchant-specific fraud assessment.

Method 400 proceeds element 414, in which the fraud-detection module 104 returns a fraud determination 113 to the risk-assessment module 106. In some embodiments, the fraud-detection module 104 may determine whether to authorize the transaction based on the fraud score 111. Continuing with the example above, in embodiments in which the fraud score 111 is provided on a scale from a −100 (indicating a very high probability of fraud) to a +100 (indicating a very low probability of fraud), the fraud-detection module 104 may determine whether to authorize the transaction based on whether the fraud score 111 is above the particular threshold value. As one non-limiting example, the fraud-detection module 104 may determine that transactions with a fraud score 111 that exceeds zero are to be authorized. Note, however, that this embodiment is provided merely as an example and is not intended to limit the scope of the present disclosure. In other embodiments, fraud-detection module 104 may generate fraud determination 113 based on fraud score 111 using various other suitable techniques. Further note that, in some embodiments, the fraud-detection module 104 may instead simply return the fraud score 111 to the risk-assessment module 106. In such embodiments, the risk-assessment module 106 may use the fraud score 111 to determine whether to authorize the transaction request 101.

In FIG. 4, method 400 then proceeds to element 416, in which the fraud-detection module 104 stores transaction data and fraud determination information for use in post-transaction analysis. For example, fraud-detection module 104 may store various items of transaction information and the fraud determination information in transaction data store 116, account data store 114, or post-analysis data store 210. As a non-limiting example, this transaction data may include user identifiers, session identifiers, event types, transaction times, origin IP addresses, or any other suitable transaction data that may be used to detect fraudulent activity. Additionally, in some embodiments, the fraud-detection module 104 may also store the fraud score 111 or any fraud determination made for the transaction request 101. In various embodiments, fraud-detection module 104 may use this historic transaction data to tune one or more of the merchant-specific fraud-detection rules 105 using various machine learning techniques.

As one non-limiting example, a first merchant-specific fraud-detection rule 105 may include one or more evaluation criteria (e.g., the number of transactions performed from a single IP address) and one or more corresponding threshold values (e.g. 10 transactions attempted from the single IP address). In various embodiments, the fraud-detection service may perform (e.g., periodically, in response to declining performance, etc.) tuning operations to tune the merchant-specific fraud-detection rules 105 in an effort to improve their efficacy. For example, the fraud-detection module 104 may retrieve metadata associated with the first fraud-detection rule 105 and apply a machine learning algorithm to transaction data associated with the merchant transaction system 120 to determine an updated threshold value for one or more of the first rule 105's evaluation criteria. The fraud-detection module 104 may evaluate the performance of the first fraud-detection rule 105 using the updated threshold value and, based on that performance, send a suggested update to the merchant transaction system 120 for the first fraud-detection rule 105. If the merchant transaction system 120 chooses to accept this suggested update, the fraud-detection module 104 may then update the rule definition for the first fraud-detection rule 105 to reflect the changes suggested by the machine learning model.

Continuing with the example above, for instance, application of the machine learning algorithm may indicate that, for the evaluation criteria of “number of transactions performed from a single IP address,” a threshold value of “5” is a more effective predictor of fraudulent activity than the previously defined threshold value of “10.” The fraud-detection module 104 may then evaluate the performance of the first fraud-detection rule 105 using this updated threshold value and, if the efficacy of the rule 105 improves, the fraud-detection module 104 may send a message to the merchant transaction system 120 (e.g., via the risk UI 122) suggesting a corresponding update to the fraud-detection rule 105. If the merchant transaction system 120 elects to accept this suggested update, the fraud-detection module 104 may then update the rule definition for the merchant-specific fraud-detection rule 105 to reflect the changes suggested by the machine learning model. Various systems and methods for tuning a fraud-detection rule using machine learning are described in more detail in pending U.S. application Ser. No. 16/389,142 titled “Tuning Fraud-Detection Rules Using Machine Learning,” filed Apr. 19, 2019.

In various embodiments, fraud-detection module 104 may provide a customizable fraud-detection service that individual merchant transaction systems 120 may elect to use in addition to the initial risk-assessment performed by the risk-assessment module 106. As noted above, the online payment system 102 may provide an interface (e.g., risk UI 122 of FIG. 1) through which the various transaction systems 120 may perform various operations associated with the merchant-specific fraud-detection service. For example, in some embodiments, the online payment system 102 may provide a web-based platform that may be accessed (e.g., by an administrator associated with the transaction system 120) via a web browser. Referring now to FIG. 5, a block diagram 500 illustrating an example risk UI 122 is shown, according to some embodiments. In various embodiments, risk UI 122 may be used to enable the fraud-detection service, define and update merchant-specific fraud-detection rules 105, view historic performance information for the merchant-specific fraud-detection service, etc.

As noted above, in some embodiments, a given merchant transaction system 120 may elect whether it wants to use an additional risk-assessment beyond that already performed by the online payment system 102. As shown in FIG. 5, risk UI 122 includes a component 502 that the merchant transaction system 120 may use to enable the merchant-specific fraud-detection service. Note that, in some embodiments, the remaining components 504-512 may be inaccessible to the merchant transaction system 120 when the fraud-detection service is disabled.

FIG. 5 further includes component 504, which the merchant transaction system 120 may use to enable a risk-assessment override option. As noted above, in some embodiments, the merchant transaction system 120 may elect to enable the risk-assessment override option for its associated transactions with the online payment system 102. For example, the merchant transaction system 120 may select the “Always” check box shown in component 504 to enable the risk-assessment override option for all transactions. In other embodiments, however, the merchant transaction system 120 may elect to conditionally enable the risk-assessment override option based on the characteristics of the transaction request being evaluated. For example, in some embodiments, the merchant transaction system 120 may specify that the risk-assessment override option is enabled for all transactions in which the transaction value is below a predetermined threshold value (e.g. $5). In various embodiments, the merchant transaction system 120 may use the risk UI to specify any number of conditions 506 and values 508 as desired to determine whether the risk-assessment override option will be enabled for a given transaction. For example, as shown in FIG. 5, when the “Conditional” check box is selected, component 504 provides a drop-down menu through which the merchant transaction system 120 may specify a condition 506A and a corresponding threshold value 508A. Note that, in some embodiments, the merchant transaction system 120 may select the conditions 506 from a set of provided conditions or may specify custom conditions 506 (e.g. using JavaScript or any other suitable language).

In the illustrated embodiment, risk UI 122 further includes a component 510 through which the merchant transaction system 120 may specify rule definitions for one or more merchant-specific fraud-detection rules 105. As described above, in various embodiments, a merchant-specific fraud-detection rule 105 may specify one or more evaluation criteria and one or more corresponding threshold values. In various embodiments, the merchant transaction system 120 may define a fraud-detection rule 105 using any suitable number of evaluation criteria and corresponding threshold values, as desired. In some embodiments, the merchant transaction system 120 may select the evaluation criteria from a set of predetermined evaluation criteria provided by the risk UI 122 (e.g. using a drop-down menu) or may specify the evaluation criteria using any suitable programming language.

FIG. 5 further includes component 512, which, in various embodiments, is used to present suggested rule updates to the merchant transaction system 120 for one or more of the merchant-specific fraud-detection rules 105. For example, as discussed above, fraud-detection module 104 (and, particularly, rule-tuning module 206) may periodically perform rule-tuning operations in which a trained machine learning model is used to generate updated threshold values for one or more of the fraud-detection rules 105. In various embodiments, the online payment system 102 may send a suggested update to a fraud-detection rule 105 to the transaction system 120 using component 512. For example, component 512 may provide a message to the merchant transaction system 120 identifying the fraud-detection rule 105 for which a suggested update has been generated. Component 512, in various embodiments, may provide additional details about the suggested rule update and the potential impact it may have on the performance of the given fraud-detection rule 105. In various embodiments, the potential impact of the suggested rule update may be expressed in terms of precision or recall, for example. In some embodiments, component 512 may further graphically depict the impact of the suggested rule update using historical transaction data for the merchant transaction system 120. For example, in some embodiments, component 512 may present a graph depicting the performance of the merchant-specific fraud-detection rule 105 over a given time period (e.g. one month) and another graph depicting the hypothetical performance of the suggested version of the merchant-specific fraud-detection rule 105 over that same time period. If the user associated with the merchant transaction system 120 accepts the suggested rule update, the fraud-detection module 104 may then update the rule information for the fraud-detection rule 105 in the account data store 114 to reflect the suggested changes to the rule 105.

### Example Computer System

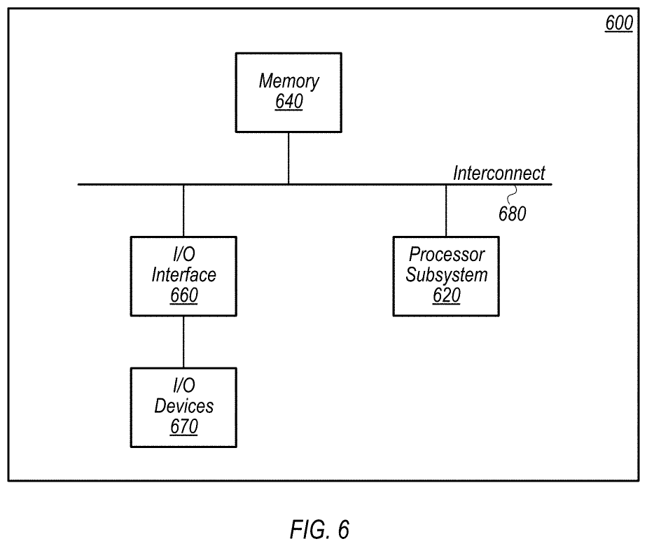

Referring now to FIG. 6, a block diagram of an example computer system 600 is depicted, which may implement one or more computer systems, such as online payment system 102 of FIG. 1, according to various embodiments. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 600 is shown in FIG. 6 for convenience, computer system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable to store program instructions executable by processor subsystem 620 to cause system 600 perform various operations described herein. System memory 640 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as system memory 640. Rather, computer system 600 may also include other forms of storage such as cache memory in processor subsystem 620 and secondary storage on I/O devices 670 (e.g., a hard drive, storage array, etc.). In some embodiments, these other forms of storage may also store program instructions executable by processor subsystem 620.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 670 includes a network interface device (e.g., configured to communicate over WiFi, Bluetooth, Ethernet, etc.), and computer system 600 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents, and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation [entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data,” for example, is intended to cover an integrated circuit that has circuitry that performs this function during operation, even if the integrated circuit in question is not currently being used a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above (e.g., fraud-detection module 104, risk-assessment module 106, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer-readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority hereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A non-transitory, computer-readable medium having instructions stored thereon that are executable by a computer system to perform operations comprising:
performing an initial risk-assessment to generate a risk score for a transaction associated with a merchant, wherein the initial risk-assessment is a merchant-neutral risk-assessment procedure applied for transactions associated with a plurality of merchants;
determining, based on the risk score, that the transaction does not pass the initial risk-assessment;
determining, based on account information associated with the merchant, whether a risk-assessment override option is enabled for the merchant, wherein the risk-assessment override option indicates that, for a given transaction associated with the merchant, a merchant-specific risk-assessment, in addition to the initial risk-assessment, is to be performed prior to rejecting the given transaction; and
in response to determining that the risk-assessment override option is enabled for the merchant, performing the merchant-specific risk assessment, including by:
accessing a definition for a merchant-specific fraud-detection rule provided by a user associated with the merchant
applying merchant-specific fraud-detection rule to transaction data associated with the transaction; and
determining whether to authorize the transaction based on an outcome of the merchant-specific fraud-detection rule.

2. The non-transitory, computer-readable medium of claim 1, wherein applying the merchant-specific fraud-detection rule includes using the risk score as an input to the merchant-specific fraud-detection rule.

3. The non-transitory, computer-readable medium of claim 1, wherein the operations further comprise:
denying the transaction in response to determining that the risk-assessment override option is disabled.

4. The non-transitory, computer-readable medium of claim 1, wherein the account information associated with the merchant specifies that:
the risk-assessment override option is enabled for transactions in which a transaction value is below a predetermined threshold; and
the risk-assessment override option is disabled for transactions in which the transaction value exceeds the predetermined threshold.

5. The non-transitory, computer-readable medium of claim 1, wherein the account information associated with the merchant specifies that:
the risk-assessment override option is enabled for transactions in which the risk score generated during the initial risk-assessment is below a predetermined threshold; and
the risk-assessment override option is disabled for transactions in which the risk score exceeds the predetermined threshold.

6. The non-transitory, computer-readable medium of claim 5, wherein the predetermined threshold is specified by the merchant.

7. The non-transitory, computer-readable medium of claim 1, wherein the merchant-specific fraud-detection rule includes a plurality of evaluation criteria used to evaluate a level of risk for transactions associated with the merchant, and wherein a threshold value for at least one of the plurality of evaluation criteria has been optimized using one or more machine learning algorithms.

8. A system, comprising:
a non-transitory memory storing instructions; and
a processor configured to execute the instructions to cause the system to:
receive a transaction request for a transaction associated with a merchant;
perform an initial risk-assessment to generate a risk score for the transaction, wherein the initial risk-assessment is a merchant-neutral risk-assessment procedure applied for transactions associated with a plurality of merchants;
determine, based on the risk score, that the transaction does not pass the initial risk-assessment;
determine, based on account information associated with the merchant, whether a risk-assessment override option is enabled for the merchant, wherein the risk-assessment override option indicates that, for a given transaction associated with the merchant, a merchant-specific risk-assessment, in addition to the initial risk-assessment, is to be performed prior to rejecting the given transaction;
in response to a determination that the risk-assessment override option is enabled for the merchant, perform the merchant-specific risk assessment, including by:
accessing a definition for a merchant-specific fraud-detection rule provided by a user associated with the merchant;
applying the merchant-specific fraud-detection rule to transaction data associated with the transaction; and
determining whether to authorize the transaction based on an outcome of the merchant-specific fraud-detection rule.

9. The system of claim 8, wherein applying the merchant-specific fraud-detection rule includes using the risk score as an input to the merchant-specific fraud-detection rule.

10. The system of claim 8, wherein executing the instructions further causes the system to deny the transaction in response to a determination that the risk-assessment override option is disabled.

11. The system of claim 8, wherein the account information associated with the merchant specifies that:
the risk-assessment override option is enabled for transactions in which a transaction value is below a predetermined threshold; and
the risk-assessment override option is disabled for transactions in which the transaction value exceeds the predetermined threshold.

12. The system of claim 11, wherein the predetermined threshold is specified by the merchant.

13. The system of claim 8, wherein the account information associated with the merchant specifies that:
the risk-assessment override option is enabled for transactions in which the risk score generated during the initial risk-assessment is below a predetermined threshold; and
the risk-assessment override option is disabled for transactions in which the risk score exceeds the predetermined threshold.

14. The system of claim 8, wherein the merchant-specific fraud-detection rule includes a plurality of evaluation criteria used to evaluate a level of risk for transactions associated with the merchant, and wherein a threshold value for at least one of the plurality of evaluation criteria has been optimized using one or more machine learning algorithms.

15. A method, comprising:
receiving, by an online payment system, a transaction request for a transaction associated with a merchant;
performing, by a risk-assessment module, an initial risk-assessment to generate a risk score for the transaction, wherein the initial risk-assessment is a merchant-neutral risk-assessment procedure applied for transactions associated with a plurality of merchants;
determining, by the risk-assessment module based on the risk score, that the transaction does not pass the initial risk-assessment;
accessing, by the online payment system, account information associated with the merchant to whether a risk-assessment override option is enabled for the merchant, wherein the risk-assessment override option indicates that, for a given transaction associated with the merchant, a merchant-specific risk-assessment, in addition to the initial risk-assessment, is to be performed prior to rejecting the given transaction;
in response to determining that the risk-assessment override option is enabled for the merchant, performing, by a fraud-detection module, the merchant-specific risk assessment, including by:
accessing a definition for a merchant-specific fraud-detection rule provided by a user associated with the merchant
applying the merchant-specific fraud-detection rule to transaction data associated with the transaction; and
generating a fraud score for the transaction based on an outcome of the merchant-specific fraud-detection rule; and
determining, by the online payment system, whether to authorize the transaction request based on the fraud score and the risk score.

16. The method of claim 15, wherein applying the merchant-specific fraud-detection rule includes using the risk score as an input to the merchant-specific fraud-detection rule.

17. The method of claim 15, wherein the account information associated with the merchant specifies that:
the risk-assessment override option is enabled for transactions in which a transaction value is below a predetermined threshold; and
the risk-assessment override option is disabled for transactions in which the transaction value exceeds the predetermined threshold.

18. The method of claim 15, wherein the account information associated with the merchant specifies that:
the risk-assessment override option is enabled for transactions in which the risk score generated during the initial risk-assessment is below a predetermined threshold; and
the risk-assessment override option is disabled for transactions in which the risk score exceeds the predetermined threshold.

19. The method of claim 18, wherein the predetermined threshold is specified by the merchant.

20. The method of claim 15, wherein the merchant-specific fraud-detection rule includes a plurality of evaluation criteria used to evaluate a level of risk for transactions associated with the merchant, and wherein a threshold value for at least one of the plurality of evaluation criteria has been optimized using one or more machine learning algorithms.
